(19) United States
(12) Patent Application Publication
(10) Pub. No.: US 2025/0178319 A1
(43) Pub. Date: Jun. 5, 2025

(54) INTERLAYERS AND LAMINATED GLAZINGS WITH LIGHT-REFLECTING BODIES

(71) Applicant: SOLUTIA INC., ST. LOUIS, MO (US)

(72) Inventors: JULIA CLAIRE SCHIMMELPENNINGH, NORTH BROOKFIELD, MA (US); MATTHIAS HALLER, FRANKFURT (DE)

(73) Assignee: SOLUTIA INC., ST. LOUIS, MO (US)

(21) Appl. No.: 18/832,092

(22) PCT Filed: Jan. 31, 2023
(86) PCT No.: PCT/US2023/061635

§ 371 Date: Jul. 22, 2024

Related U.S. Application Data
(60) Provisional application No. 63/267,682, filed on Feb. 8, 2022.

(51) Int. Cl. B32B 17/10

(52) U.S. Cl. CPC B32B 17/10614; B32B 17/10036; B32B 2250/02; B32B 2307/412; B32B 2307/416

(57) ABSTRACT

An interlayer for a laminated composite is disclosed. The interlayer of the present invention includes a polymer resin composition and an interlayer thickness and comprises a plurality of visible, light-reflecting bodies, wherein the visible, light-reflecting bodies include a first set of visible, light-reflecting bodies arranged in a first substantially coplanar arrangement in a first plane XY1 within said interlayer thickness and a second set of visible, light-reflecting bodies arranged in a second substantially coplanar arrangement in a second plane XY2 within said interlayer thickness that is substantially parallel to and different from said first plane. A composite glazing laminate and methods for forming a laminated composite glazing are also described.

### FIELD OF THE INVENTION

The present invention generally relates to the field of laminated glazing interlayers and laminated glazing composites including, formed from or prepared using such interlayers.

### BACKGROUND OF THE INVENTION

As has been known in the art for many years, laminated glass or laminated glazing constructions that include a monolithic sheet or multilayer laminate of polymeric material such as polyvinyl butyral (often referred to in the art as an interlayer) sandwiched between rigid substrates formed of glass or transparent polymer material have well-established commercial utility in safety glass and security glass applications in the automotive and architectural markets. In these applications, characteristics such as penetration resistance, optical quality and durability are of paramount importance to commercial success.

In many of these applications, products that further include visually decorative or aesthetic features (while retaining other overall performance characteristics) may be desirable. For example, U.S. Pat. Nos. 6,824,868 and 7,727,634, assigned to a predecessor of the assignee of the present invention, generally describe decorative glass laminates and interlayers therefor wherein the interlayers include an ultraviolet printed image. More generally, decorative interlayer and laminated glass constructions are described in U.S. Published Patent Application number US20070172637A1.

Applications wherein a laminated glass or related interlayer construction includes contrasting or variable optical features such as transparency or visual detectability are also known. For example, U.S. Published Patent Application 2020/0262185A1 describes a so-called one-way laminated glass for installation in facades or for interior design that includes a interlayer composite arranged between and bonded to first and second glass panes and wherein a large number of paillettes with a light absorbing surface are arranged between first and second interlayers to achieve a visual effect. Further, U.S. Pat. No. 4,997,687 describes a patterned product having a three-dimensional appearance that includes a transparent substrate with a discontinuous pattern coating in combination with a second pattern coating on a separate surface wherein the second pattern coating is visible through the discontinuous pattern coating. Also, U.S. Published Patent Application No. 2007/0044731A1 describes a “bird friendly” glass product that includes a pattern which is visible to the normal avian eye but which may or may not be visible to the normal human eye.

Despite these advances in the art, there remains a continuing unmet need for interlayers and related laminated glass constructions that meet customer desires and expectations for new and improved decorative effect, visual impression, attractiveness, aesthetics and visual noise creation while maintaining the quality, safety and performance attributes required in laminated glass applications.

### SUMMARY OF THE INVENTION

In a first aspect, the present invention is directed to an interlayer for a laminated composite. The interlayer of the present invention includes a polymer resin composition and an interlayer thickness and comprises a plurality of visible, light-reflecting bodies. The visible, light-reflecting bodies include a first set of visible, light-reflecting bodies arranged in a first substantially coplanar arrangement in a first plane XY1 within said interlayer thickness and a second set of visible, light-reflecting bodies arranged in a second substantially coplanar arrangement in a second plane XY2 within said interlayer thickness that is substantially parallel to and different from said first plane.

In a second aspect, the present invention is directed to a laminated composite glazing. The laminated composite glazing of the present invention includes first and second transparent substrates with an interlayer therebetween, said interlayer comprising a polymer resin composition and an interlayer thickness; wherein the interlayer comprises a plurality of visible, light-reflecting bodies and wherein the plurality of visible, light-reflecting bodies includes a first set of visible, light-reflecting bodies arranged in a first substantially coplanar arrangement in a first plane XY1 within said interlayer thickness and a second set of visible, light-reflecting bodies arranged in a second substantially coplanar arrangement in a second plane XY2 within said interlayer thickness that is substantially parallel to and different from said first plane.

In a third aspect, the present invention is directed to a method for forming a laminated composite glazing comprising first and second transparent substrates with an interlayer therebetween. In this aspect, the method of the present invention comprises the steps of (a) providing first and second interlayer component sheets, each interlayer component sheet comprising a substrate and a plurality of visible, light-reflecting bodies; (b) assembling said first and second interlayer component sheets to form a multilayer interlayer precursor; (c) assembling a laminated composite glazing precursor comprising first and second transparent substrates with said multilayer interlayer precursor therebetween; and (d) subjecting said laminated composite glazing precursor to laminating conditions to form a laminated composite glazing. In embodiments, the method optionally further comprises inserting an optional spacer sheet, preferably without visible, light-reflecting bodies, between the first and second interlayer component sheets.

In a fourth aspect, the present invention is directed to a method for forming a laminated composite glazing comprising first and second transparent substrates with an interlayer therebetween. In this aspect, the method of the present invention comprises the steps of (a) providing an interlayer with a thickness and comprising (i) a substrate comprising a polymer resin composition and (ii) a plurality of visible, light-reflecting bodies; wherein said plurality of visible, light-reflecting bodies includes a first set of visible, light-reflecting bodies arranged in a first substantially coplanar arrangement in a first plane within said interlayer thickness and a second set of visible, light-reflecting bodies arranged in a second substantially coplanar arrangement in a second plane within said interlayer thickness that is substantially parallel to and different from said first plane, said interlayer comprising a substrate and a plurality of visible, light-reflecting bodies; (b) assembling a laminated composite glazing precursor comprising first and second transparent substrates with said multilayer interlayer precursor therebetween; and (d) subjecting said laminated composite glazing precursor to laminating conditions to form a laminated composite glazing.

Further aspects of the invention are as disclosed and claimed herein.

### BRIEF DESCRIPTION OF THE DRAWINGS

FIG. 1 is a front perspective view in cross-section of an embodiment of an interlayer of the present invention;

FIG. 2 is a front perspective view in cross-section of an embodiment of a laminated composite glazing of the present invention;

FIG. 3 is a top plan view of an embodiment of the laminated composite glazing of the present invention with substrates and interlayers transparent to show an arrangement of visible, light-reflecting bodies;

FIG. 4 is a top plan view of an embodiment of the laminated composite glazing of the present invention with substrates and interlayers transparent to show an arrangement of visible, light-reflecting bodies;

FIG. 5 is an exploded front perspective view in cross-section of an interlayer and interlayer precursor as applicable to an embodiment of a method of the present invention;

FIG. 6 is an exploded front perspective view in cross-section of the components of a laminated composite glazing as applicable to an embodiment of a method of the present invention; and

FIG. 7 is an exploded front perspective view in cross-section of the components of a laminated composite glazing as applicable to an embodiment of another method of the present invention.

### DETAILED DESCRIPTION

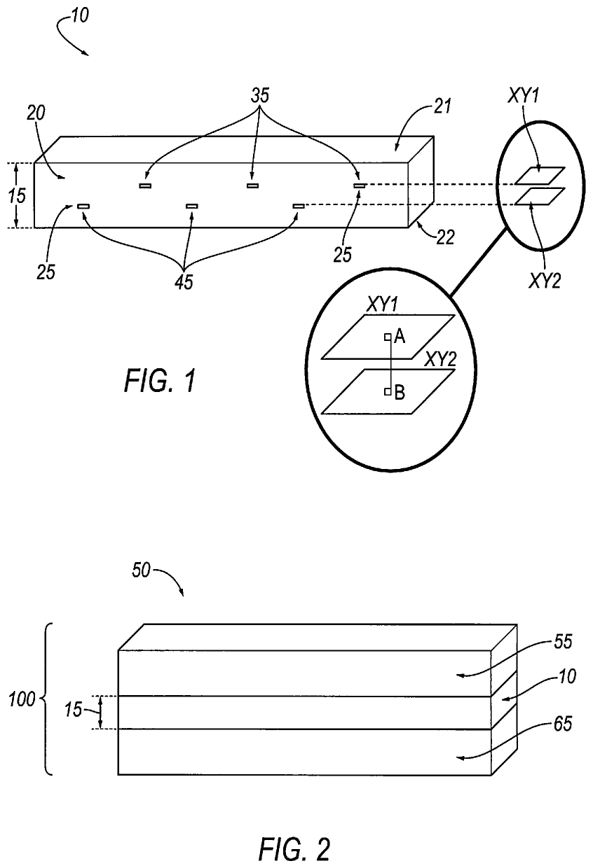

In a first aspect, the present invention is directed to an interlayer for a laminated composite. An embodiment of the interlayer 10 of the present invention, depicted particularly but non-exclusively in FIGS. 1 and 2, includes an interlayer thickness 15 and comprises a polymer resin composition and plurality of visible, light-reflecting bodies 25, wherein said plurality of visible, light-reflecting bodies 25 includes a first set 35 of visible, light-reflecting bodies 25 arranged in a first substantially coplanar arrangement in a first plane XY1 within said interlayer thickness 15 and a second set 45 of visible, light-reflecting bodies 25 arranged in a second substantially coplanar arrangement in a second plane XY2 within said interlayer thickness 15 that is substantially parallel to and different from said first plane.

As used herein, the term “interlayer” refers to a single or multiple layer polymer-based sheet that may be suitable for use with at least one rigid substrate to form a composite substrate. The interlayer of the present invention may be “monolithic”, meaning that the interlayer includes or may be formed of a single polymer layer, or may be a “multiple layer” or “multilayer” interlayer, which refers to interlayers including two or more layers which may typically be stacked upon one another, that are coextruded, laminated, or otherwise coupled to each other. One of ordinary skill will appreciate that interlayers formed from multiple component sheets, while definitionally multilayer in form, could take the appearance or form of a “monolithic” interlayer when for example the component sheets are compressed during a glazing lamination process. Such a result may occur for example when the component sheets are the same or materially similar in chemical composition.

As used herein, the terms “polymer resin sheet” and “resin sheet” refer to one or more polymer resins, optionally combined with one or more plasticizers and other ingredients, combined to form a polymer resin composition that is formed into a sheet. Polymer sheets may further include one or more additional additives and may comprise one or more resin layers. In some embodiments, the polymer sheet may be an intermediate polymer resin sheet or interlayer precursor used to form one or more of the interlayers described herein. Multiple polymer sheets may be combined together to form a multiple layer interlayer. Further, additional functional layers or sheets, such as a polyethylene terephthalate (PET) film, a coated PET film, or other layer, may also be included when multiple polymer sheets are combined to for an interlayer herein.

The interlayer or the polymer sheet(s) of the interlayer of the present invention includes, is formed from or is prepared using a polymer resin composition(s). The polymer resin composition may include various polymer resins known in the art for interlayer manufacture. The resin compositions may typically include one or more polymeric resins, optionally combined with one or more plasticizers, which have been formed into a sheet by any suitable method. In various embodiments, the interlayer or sheet or layer includes a polymer or polymer resin or resin composition that comprises a poly(vinyl acetal) resin and in particular a polyvinyl butyral (PVB) resin. PVB resin is produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Wade, B. (2016), “Vinyl Acetal Polymers”, Encyclopedia of Polymer Science and Technology, pp. 1-22 (John Wiley & Sons, Inc.), the entire disclosures of which are incorporated herein by reference to the extent not inconsistent with the present disclosure. The PVB resin is commercially available in various forms, for example, as Butvar® Resin from Solutia Inc. (which is a wholly owned subsidiary of Eastman Chemical Company). Examples of suitable types of poly(vinyl acetal) resins are described in detail in U.S. Publication No. 2016/0159041A1, assigned to the assignee of the present invention, the entirety of which is incorporated herein by reference to the extent not inconsistent with the present disclosure.

In one or more embodiments, the polymer resin composition, sheet or layer may include two or more polymer resins such as a polymer resin blend. In one or more embodiments, the two or more polymer resins may comprise two different types of polymer resins or two different polymer resins of the same polymer resin class. In one or more embodiments, an interlayer, layer or sheet may include two or more poly(vinyl acetal) resins having different levels of residual hydroxyl content (such as where the residual hydroxyl contents and/or the residual acetate contents are different).

In one or more embodiments, the polymer resin composition, interlayers, sheets or layers of the present invention include or are formed or prepared using a polymer resin that includes polymer resin (as discussed above) and optionally at least one plasticizer. In some embodiments, examples of the plasticizer include esters of a polybasic acid or a polyhydric alcohol, among others. Suitable plasticizers include, for example, triethylene glycol di-(2-ethylhexanoate) (“3GEH”), triethylene glycol di-(2-ethylbutyrate), triethylene glycol diheptanoate, tetraethylene glycol diheptanoate, dihexyl adipate, dioctyl adipate, hexyl cyclohexyladipate, diisononyl adipate, heptylnonyl adipate, dibutyl sebacate, di(butoxyethyl) adipate, bis(2-(2-butoxyethoxy)ethyl) adipate, and mixtures thereof. In some embodiments, the plasticizer is 3GEH.

In some embodiments, the plasticizer may be a high refractive index plasticizer. Examples of high refractive index plasticizers include, but are not limited to, esters of a polybasic acid or a polyhydric alcohol, polyadipates, epoxides, phthalates, terephthalates, benzoates, toluates, mellitates and other specialty plasticizers, among others. Examples of suitable plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), and mixtures thereof. Examples of particularly suitable high refractive index plasticizers are dipropylene glycol dibenzoates, tripropylene glycol dibenzoates, and 2,2,4-trimethyl-1,3-pentanediol dibenzoate.

The polymer resin composition may comprise 0 to about 120, 0 to about 80, about 0 to 45, about 10 to about 75, about 15 to about 60, about 25 to about 50, about 15 to about 50, about 10 to about 40, about 15 to about 40, about 25 to about 38, about 29 to about 32, and about 30 phr (parts per hundred parts resin) plasticizer or a mix of plasticizers. The polymer resin composition may comprise 0, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95 and at least 100 phr (parts per hundred parts resin) plasticizer or a mix of plasticizers. The polymer resin composition may comprise less than 120, less than 115, less than 110, less than 105, less than 100, less than 95, less than 90, less than 85, less than 80, less than 75, less than 70, less than 65, less than 60, less than 55, less than 50, less than 45, less than 40, less than 35, less than 40, less than 35, less than 30, less than 25, less than 20, less than 15, less than 10, and less than 5 phr (parts per hundred parts resin) plasticizer or a mix of plasticizers. While the interlayers or sheets or layers of the present invention may include at least one plasticizer in the above amounts, it will be understood by one of ordinary skill in the art that plasticizer amount and quantities can be selected as appropriate for the particular application and the desired properties. In various embodiments of interlayers of the present disclosure, an interlayer, sheet or layer may comprise greater than 5 phr, about 5 to about 100 phr, about 10 to about 80 phr, about 30 to about 60 phr, or less than 100 phr, or less than 80 phr total plasticizer. One of ordinary skill will appreciate that, in multilayer interlayer embodiments, the plasticizer selection and content in each individual layer may be selected as appropriate for the desire properties of the particular application and the desired properties of the individual layer as well the overall properties and application of the interlayer.

In addition to polymer resin and optional plasticizer, the polymer resin composition (and accordingly the interlayer, layer or sheet) may include other additives may be incorporated into the interlayer to enhance its performance in a final product and impart certain additional properties to the interlayer. Such additives include, but are not limited to, dyes, pigments, antioxidants, anti-blocking agents, flame retardants, IR absorbers or blockers (e.g., indium tin oxide, antimony tin oxide, lanthanum hexaboride (LaB₆) and cesium tungsten oxide), UV absorbers, UV stabilizers, processing aids, flow enhancing additives, adhesion agents, lubricants, impact modifiers, nucleating agents, thermal stabilizers, dispersants, surfactants, chelating agents, coupling agents, adhesives, primers, reinforcement additives, and fillers, among other additives known to those of ordinary skill in the art.

Interlayers, sheets of layers as described herein may be produced by any suitable process known to one of ordinary skill in the art of producing polymer interlayer sheets that are capable of being used in a multiple layer glazing. For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where the interlayer, or one or more layers of the interlayer, is a multilayer interlayer, it is contemplated that these multilayers interlayers may be formed through co-extrusion, blown film, dip coating, solution coating, blade, paddle, air-knife, printing, powder coating, spray coating or other processes known to those of ordinary skill in the art. While all methods for the production of interlayers, sheets and layers known to one of ordinary skill in the art are contemplated as possible methods for producing the polymer interlayer sheets described herein, the present invention focuses primarily but not exclusively on interlayers, sheets and layers produced through extrusion and co-extrusion processes.

The interlayer of the present invention includes a thickness or thickness dimension 15 which may also be referred to as the interlayer's gauge. Generally, the thickness or gauge of the interlayer 15 may be in a range from about 15 mils to 1000 mils (about 0.38 mm to about 25.4 mm). Where the interlayer 15 comprises multiple polymer layers or sheets comprising light-reflecting bodies, each polymer layer or sheet having the light-reflecting bodies may have a thickness of about 15 mils to 60 mils (about 0.38 mm to about 1.52 mm), although other thicknesses may be selected as desired. In embodiments where the interlayer is a multilayer interlayer comprising additional layers, each of the additional layers may have a thickness of about 1 mil to 1000 mils (about 0.025 to 25.4 mm), although other thicknesses may be used as desired depending on the application.

As depicted particularly but non-exclusively in FIGS. 1 and 2, the interlayer of the present invention further includes a plurality of visible, light-reflecting bodies 25 within said interlayer thickness 15. In one or more embodiments, the visible, light-reflecting bodies 25 include a first set 35 of visible, light-reflecting bodies 25 arranged in a first substantially coplanar arrangement in a first plane depicted as “XY1” in FIG. 1 within said interlayer thickness and a second set 45 of visible, light-reflecting bodies 25 arranged in a second substantially coplanar arrangement in a second plane depicted as “XY2” in FIG. 1 within said interlayer thickness wherein the second plane is substantially parallel to and different from said first plane.

The interlayer of the present invention includes a plurality of visible, light-reflecting bodies 25. As used herein, the phrase “visible, light-reflecting bodies” is intended to generally describe articles that reflect electromagnetic energy from at least one surface in at least a portion of the wavelength range that is visible to or detectable by humans. In one or more embodiments, the visible, light-reflecting bodies reflect electromagnetic energy in at least a portion of the wavelength range from 250 nm to 2500 nm. In one or more embodiments, the phrase “visible, light-reflecting bodies” is intended to generally describe articles that reflect electromagnetic energy in at least portion of the wavelength range that is visible to or detectable by most common bird species. In one or more embodiments, the visible, light-reflecting bodies reflect electromagnetic energy in at least a portion of the wavelength range from 250 nm to 700 nm.

In one or more embodiments, the visible, light-reflecting bodies 25 may also absorb electromagnetic energy, particularly electromagnetic energy in at least portion of the wavelength range that is visible to or detectable by humans and/or may also absorb electromagnetic energy in at least portion of the wavelength range that is visible to or detectable by common bird species. In one or more embodiments, the visible, light-reflecting bodies 25 may also absorb electromagnetic energy, particularly electromagnetic energy in at least portion of the wavelength range of 250 nm to 2500 nm and/or may also absorb electromagnetic energy in at least portion of the wavelength range of 250 nm to 400 nm (bird species). In one or more embodiments, the visible, light-reflecting bodies 25 may include a visible, light-reflecting surface and an opposite visible, light absorbing surface.

The visible, light-reflecting bodies may be of any design, shape, size or configuration that is capable of reflecting (and, in some embodiments, absorbing) electromagnetic energy in the ranges described above. One example of suitable visible, light-reflecting bodies is described for example in U.S. Published Patent Application Number 2020/0262185A1, the contents and disclosure of which are hereby incorporated herein by reference to the extent not inconsistent with the present disclosure. The visible, light-reflecting bodies may be capable of reflecting and in some embodiments absorbing electromagnetic energy on either surface or side of the bodies. Additionally, in some embodiments, the visible, light-reflecting bodies may include a surface with a color generally referred to as silver, but any suitable color(s) may be used as desired. For example, one side or surface of the visible, light-reflecting bodies may be a silver or “shiny” color, while the other or opposite side may be a darker color such as black.

The first set 35 of light-reflecting bodies 25 are arranged in a substantially coplanar arrangement (referred to as the first substantially coplanar arrangement) within the interlayer thickness. The term “within” as used to describe the location of the light-reflecting bodies is broadly intended to include locations in the interior 20 of the interlayer thickness as well as locations generally on surfaces 21 and 22 and/or the interior 20 of the interlayer thickness 15.

In one or more embodiments, at least one of the first set 35 of light-reflecting bodies 25 and the second set 45 of light-reflecting bodies 25 are arranged in a first substantially coplanar arrangement in the interior of the interlayer thickness 15. In one or more embodiments at least one of or both of the first set 35 of light-reflecting bodies 25 and the second set 45 of light-reflecting bodies 25 are arranged in a first substantially coplanar arrangement wholly in the interior 20 of the interlayer thickness 15. In one or more embodiments, the surfaces 21 and 22 of the interlayer thickness 15 are devoid of visible, light-reflecting bodies 25.

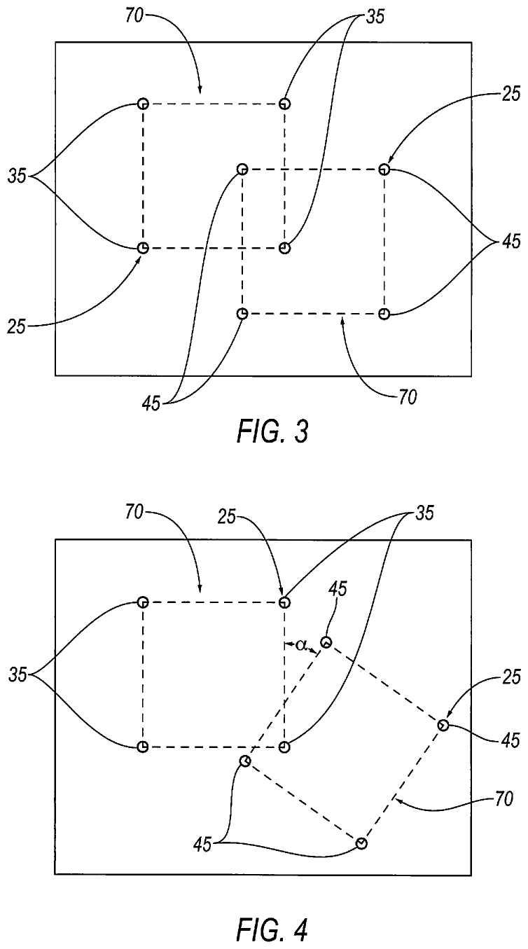

In one or more embodiments, at least one of said first substantially coplanar arrangement and said second substantially coplanar arrangement comprises a grid pattern 70. As used herein, the phrase “grid pattern” is intended to describe substantially coplanar arrangements wherein imaginary lines (shown as dotted lines in FIGS. 3 and 4) connecting the visible, light-reflecting bodies of the arrangement form a regular pattern of geometric elements. Non-limiting examples of grid patterns may include rectangles (including more specifically squares as depicted in as FIGS. 3 and 4), triangles, zigzagged lines, parallel lines, intersecting lines or the like. In one or more embodiments, at least one of said first substantially coplanar arrangement and said second substantially coplanar arrangement comprises a rectangular grid pattern. In one or more embodiments, both said first substantially coplanar arrangement and said second substantially coplanar arrangement comprise a grid pattern or preferably a rectangular grid pattern. In one or more embodiments wherein both the first substantially coplanar arrangement and the second substantially coplanar arrangement comprise a grid pattern, the first substantially coplanar arrangement comprises a first grid pattern and the second substantially coplanar arrangement comprises a second grid pattern.

In embodiments wherein both said first substantially coplanar arrangement and said second substantially coplanar arrangement comprise a grid pattern or preferably a rectangular grid pattern, the first grid pattern and the second grid pattern may be staggered. As used herein, the term “staggered” is intended to describe the spatial relationship between a first grid pattern and a second grid pattern wherein (except for minimal random occurrences) no visible, light-reflecting bodies included in the first grid pattern form an imaginary line with a visible, light-reflecting body included in the second grid pattern that is normal to the first and second planes XY1 and XY2. For reference, a magnified excerpt of FIG. 1 shows a line AB generally normal to first and second planes XY1 and XY2.

Two non-limiting examples of “staggered” spatial relationships contemplated by the present invention include “linearly offset” and “angularly offset”. As used herein, the phrase “linearly offset” is intended to describe spatial relationships between the first and second grid patterns wherein geometric elements of the second grid pattern are offset from the geometric elements of the first grid pattern in an X direction and a Y direction. A non-limiting example of a linear offset arrangement using first and second grid patterns with square geometric elements is depicted in FIG. 3. As used herein, the phrase “angularly offset” is intended to describe spatial relationships between first and second grid patterns wherein the geometric elements of the second grid pattern are offset with a rotational offset angle from the geometric elements of the first grid pattern. A non-limiting example of an angularly offset arrangement using first and second grid patterns with square geometric elements is depicted in FIG. 4, with the rotational offset angle shown as alpha (a). In one or more embodiments, the rotational offset angle α is between 0.1 and 90 degrees or between 90.1 and 179.9 degrees.

In another and related aspect, the present invention relates to a composite 50 comprising an interlayer 10 and a rigid substrate 45 or more particularly a laminated glazing or laminated glazing composite 50 comprising first and second rigid substrates 55 and 65 with an interlayer 10 therebetween. The substrates 45, 55 and 65 may be transparent, and in many applications, will be transparent. In this aspect, the present invention is directed to a composite 50 comprising an interlayer 10 and a rigid substrate 45 or a laminated glazing composite 50 comprising first and second transparent substrates 55 and 65 with an interlayer 10 therebetween, said interlayer comprising a polymer resin composition and an interlayer thickness 15; wherein said interlayer 10 comprises a plurality of visible, light-reflecting bodies 25; wherein said plurality of visible, light-reflecting bodies 25 includes a first set of visible, light-reflecting bodies 35 arranged in a first substantially coplanar arrangement in a first plane XY1 within said interlayer thickness 15 and a second set 45 of visible, light-reflecting bodies 25 arranged in a second substantially coplanar arrangement XY2 in a second plane within said interlayer thickness that is substantially parallel to and different from said first plane.

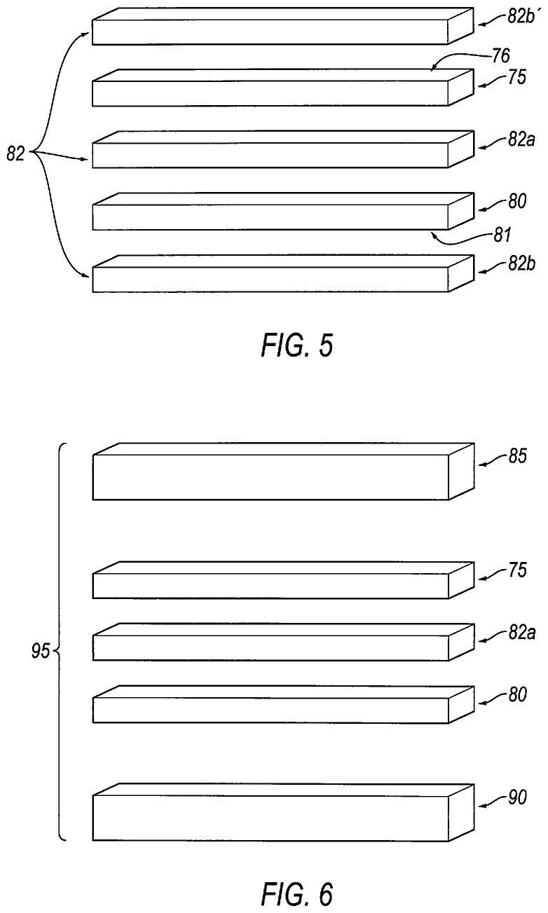

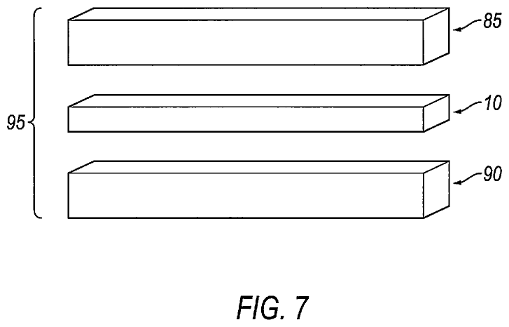

In yet another aspect and with particular but non-exclusive reference to FIGS. 2, 5 and 6, the present invention relates to a method for forming a laminated composite glazing that comprises first and second transparent substrates with an interlayer therebetween. The method of the present invention comprises the steps of (a) providing first and second interlayer component sheets 75 and 80, each interlayer component sheet comprising a polymer resin composition and a plurality of visible, light-reflecting bodies 25; (b) assembling said first and second interlayer component sheets 75 and 80 to form a multilayer interlayer precursor 83; (c) assembling a laminated composite glazing precursor 95 comprising first and second transparent rigid substrates 55 and 60 with said multilayer interlayer precursor 83 therebetween; and (d) subjecting said laminated composite glazing precursor 95 to laminating conditions to form a laminated composite glazing 100 that includes first and second rigid transparent substrates 55 and 65 with an interlayer 10 therebetween. In one or more embodiments, the first and second interlayer component sheets 75 and 80 are assembled in an adjacent stacked arrangement in assembling step (b). In one or more embodiments, step (b) of assembling the first and second interlayer component sheets 75 and 80 to form a multilayer interlayer precursor 83 may further include inserting one or more optional component sheets, generally depicted in FIG. 5 as element(s) 82. In one or more embodiments, optional interlayer component sheets do not include visible, light-reflecting bodies. In one or more embodiments, optional interlayer component sheet is a spacer sheet (shown in FIG. 5 as element 82a) located between the first and second interlayer component sheets 75 and 80. Accordingly, in one or more embodiments, step (b) of assembling the first and second interlayer component sheets 75 and 80 to form a multilayer interlayer precursor 83 may further include inserting one or more optional spacer sheet(s) 82a between the first and second interlayer component sheets 75 and 80. In one or more embodiments, the optional interlayer component sheet may be an optional cap sheet (shown in FIG. 5 as elements 82b and 82b′) located adjacent an opposing or outwardly facing surface 76 or 81 of an interlayer component sheet 75 or 80 or between one or more interlayer component sheets 75 or 80 and one or more transparent substrates. Accordingly, in one or more embodiments, step (b) of assembling the first and second interlayer component sheets 75 and 80 to form a multilayer interlayer precursor 83 may further include inserting one or more optional cap sheets adjacent an opposing or outwardly facing surface 76 or 81 respectively of at least one of the first and second interlayer component sheets 75 and 80 or between an interlayer component sheet and a transparent substrate. An optional interlayer component sheet 82 may be any thickness as desired and previously described, and may be thinner or thicker than the first and second interlayer component sheets 75 and 80. An optional interlayer component sheet may also be any thickness as desired, and may be thinner or thicker than the first and second interlayer component sheets 75 and 80. In a further embodiment, step (b) of assembling the first and second interlayer component sheets 75 and 80 to form a multilayer interlayer precursor 83 may include inserting both an optional spacer sheet(s) 82a and an optional cap sheet 82b and/or 82b′. In another embodiment, the first and second interlayer component sheets 75 and 80 may be positioned such that the visible, light-reflecting bodies 25 are on the same side or surface of the interlayer component sheets or facing surfaces of the first and second interlayer component sheets 75 and 80 or at the same interface or at one or more surfaces of the first and second interlayer component sheets 75 and 80 facing one or more transparent substrates. In yet another embodiment, there may be an optional layer located between at least one of the first and second interlayer sheets 75 and 80, adjacent the rigid substrate. This layer may be another polymer layer of the same or different composition, and it may have the same or different properties (such as a decorative color, solar absorbing properties, or other function or property) as one or both of the interlayer sheets 75 and 80. Regardless of the embodiment utilized, it may be appreciated by one or ordinary skill and should be understood that placement, position, orientation and arrangement of the first and second interlayer sheets 75 and 80 in the assembling step (b) may be selected such that the interlayer of the laminated composite glazing produced according to the method includes a first set of visible, light-reflecting bodies 35 arranged in a first substantially coplanar arrangement in a first plane XY1 and a second set 45 of visible, light-reflecting bodies 25 is arranged in a second substantially coplanar arrangement XY2 in a second plane within said interlayer thickness that is substantially parallel to and different from said first plane.

In the method of this aspect, first and second interlayer component sheets 75 and 80 each include a polymer resin composition and a plurality of visible, light-reflecting bodies 25. In one or more embodiments, first and second interlayer component sheets 75 and 80 each comprise a plurality of visible, light-reflecting bodies on at least one surface thereof. As described in the method of this aspect, the first and second interlayer component sheets 75 and 80 form a multilayer interlayer precursor 83 in assembling step (b) and then form interlayer 10 in assembling step (c). Further, the visible, light-reflecting bodies 25 of the first interlayer component sheet 75 form and correspond to the first set of light-reflecting bodies 35 of the interlayer 10 while the visible, light-reflecting bodies 25 of the second interlayer component sheet 80 form and correspond to the second first set of light-reflecting bodies 45 of the interlayer 10. Accordingly, in one or more embodiments, assembling step (b) includes arranging first and second interlayer component sheets 75 and 80 such that the interlayer of the laminated composite glazing produced according to the method includes a first set of visible, light-reflecting bodies 35 arranged in a first substantially coplanar arrangement in a first plane XY1 and a second set 45 of visible, light-reflecting bodies 25 is arranged in a second substantially coplanar arrangement XY2 in a second plane within said interlayer thickness that is substantially parallel to and different from said first plane.

In one or more embodiments, at least one of or both of the first and second interlayer component sheets 75 and 80 comprise a plurality of visible, light-reflecting bodies arranged in a substantially coplanar arrangement. In one or more embodiments, at least one of or both of the first and second interlayer component sheets 75 and 80 comprise a plurality of visible, light-reflecting bodies arranged on a surface thereof. In one or more embodiments, at least one of or both of the first and second interlayer component sheets 75 and 80 comprise a plurality of visible, light-reflecting bodies 25 arranged in a substantially coplanar arrangement that comprises a grid pattern.

One of ordinary skill will appreciate that, in practicing the method of this aspect of the present invention, the interlayer component sheets 75 and 80 may or may not (depending on factors such as for example laminating conditions and variables, equipment and settings) completely combine or integrate in forming the interlayer 10 resulting from assembling step (c). Accordingly, in one or more embodiments, the interlayer may be characterized as a monolithic interlayer while, in one or more embodiments, the interlayer 10 may be characterized as a multilayer interlayer. Further, in one or more embodiments, the interlayer may be a hybrid interlayer 10 with both monolithic and multilayer portions. In embodiments, the interlayer 10 may include additional layers that may or may not be polymeric layers, or may be layers of different polymer compositions and/or functionality, as previously described.

In still another aspect, the method of the present invention is a method for forming a laminated composite glazing comprising first and second transparent substrates with an interlayer therebetween, said method comprising the steps of (a) providing an interlayer 10 with a thickness 15 and comprising (i) a polymer resin composition and (ii) a plurality of visible, light-reflecting bodies 25; wherein said plurality of visible, light-reflecting bodies includes a first set of visible, light-reflecting bodies 35 arranged in a first substantially coplanar arrangement in a first plane XY1 within said interlayer thickness 15 and a second set 45 of visible, light-reflecting bodies arranged in a second substantially coplanar arrangement in a second plane XY2 within said interlayer thickness 15 that is substantially parallel to and different from said first plane; (b) assembling a laminated composite glazing precursor 95 comprising first and second transparent substrates 85 and 90 with said interlayer 10 therebetween; and (d) subjecting said laminated composite glazing precursor 95 to laminating conditions to form a laminated composite glazing 100.

Laminated glazings and laminated composite glazing composites such as those described herein and those including interlayers of the present invention are prepared by known procedures, e.g., as disclosed in U.S. Pat. Nos. 5,024,895; 5,091,258; 5,145,744; 5,189,551; 5,264,058 and 5,529,654 (all of which are incorporated herein by reference). In general, an interlayer is placed between two sheets of rigid substrates (such as glass) and deaired through nip rollers, calendar rollers or with vacuum to remove excess air between the interlayers and the interlayers and glass surface. The deaired laminated composite glazing is the heated, optionally under pressure, for a sufficient time at a sufficient temperature to firmly bond the layers of the laminate. This process is done in both an autoclave or non-autoclave methods as known in the art, and for example, as disclosed in U.S. Pat. No. 5,536,347, incorporated herein by reference.

One of ordinary skill will understand and appreciate that elements or features used to describe one aspect or embodiment of the present invention may be applicable and useful in describing other aspects or embodiments. By way of non-limiting example, the description of a visible, light-reflecting body set forth in the context of the interlayer of the present invention is also applicable and useful in describing the visible, light-reflecting body in the context of composites and laminated composite glazing composites and methods of the present invention. Accordingly, descriptions and disclosure relating to elements or features of an aspect or embodiment of the present invention are hereby expressly relied on to describe and support those elements or features in other aspects or embodiments.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

The present invention and its preferred embodiments is now further described in terms of numbered Items 1 to 24.

Item 1. An interlayer for a laminated composite, said interlayer comprising an interlayer thickness, a polymer resin composition and a plurality of visible, light-reflecting bodies; wherein said plurality of visible, light-reflecting bodies includes a first set of visible, light-reflecting bodies arranged in a first substantially coplanar arrangement in a first plane XY1 within said interlayer thickness and a second set of visible, light-reflecting bodies arranged in a second substantially coplanar arrangement in a second plane XY2 within said interlayer thickness that is substantially parallel to and different from said first plane.

Item 2. The interlayer of Item 1 wherein at least one of said first substantially coplanar arrangement and said second substantially coplanar arrangement comprises a grid pattern.

Item 3. The interlayer of Item 2 wherein said first substantially coplanar arrangement comprises a first grid pattern and said second substantially coplanar arrangement comprises a second grid pattern.

Item 4. The interlayer of Item 3 wherein said first grid pattern and said second grid pattern each comprise a rectangular grid pattern.

Item 5. The interlayer of Item 4 wherein said second grid pattern is staggered from said first grid pattern.

Item 6. The interlayer of Item 5 wherein said second grid pattern is linearly offset from said first grid pattern.

Item 7. The interlayer of Item 4 wherein said second grid pattern is angularly offset from said first grid pattern.

Item 8. The interlayer of Item 7 wherein first grid pattern is angularly offset from said second grid pattern at an angular offset angle of from 1 to 89 degrees.

Item 9. A laminated composite glazing composite comprising first and second transparent substrates with an interlayer therebetween, said interlayer comprising a polymer resin composition and an interlayer thickness; wherein said interlayer comprises a plurality of visible, light-reflecting bodies; wherein said plurality of visible, light-reflecting bodies includes a first set of visible, light-reflecting bodies arranged in a first substantially coplanar arrangement in a first plane XY1 within said interlayer thickness and a second set of visible, light-reflecting bodies arranged in a second substantially coplanar arrangement in a second plane XY2 within said interlayer thickness that is substantially parallel to and different from said first plane.

Item 10. The laminated composite glazing composite of Item 9 wherein at least one of said first substantially coplanar arrangement and said second substantially coplanar arrangement comprises a grid pattern.

Item 11. The laminated composite glazing composite of Item 10 wherein said first substantially coplanar arrangement comprises a first grid pattern and said second substantially coplanar arrangement comprises a second grid pattern.

Item 12. The laminated composite glazing composite of Item 11 wherein said first grid pattern and said second grid pattern each comprise a rectangular grid pattern.

Item 13. The laminated composite glazing composite of Item 12 wherein said second grid pattern is staggered from said first grid pattern.

Item 14. The laminated composite glazing composite of Item 13 wherein said second grid pattern is linearly offset from said first grid pattern.

Item 15. The laminated composite glazing composite of Item 11 wherein said second grid pattern is angularly offset from said first grid pattern.

Item 16. The laminated composite glazing composite of Item 15 wherein first grid pattern is angularly offset from said second grid pattern at an angular offset angle of from 1 to 89 degrees.

Item 17. A method for forming a laminated composite glazing comprising first and second transparent substrates with an interlayer therebetween, said method comprising the steps of (a) providing first and second interlayer component sheets, each interlayer component sheet comprising a substrate and a plurality of visible, light-reflecting bodies; (b) assembling said first and second interlayer component sheets to form a multilayer interlayer precursor; (c) assembling a laminated composite glazing precursor comprising first and second transparent substrates with said multilayer interlayer precursor therebetween; and (d) subjecting said laminated composite glazing precursor to laminating conditions to form a laminated composite glazing.

Item 18. The method of Item 17 wherein said first and second interlayer component sheets each comprise a plurality of visible, light-reflecting bodies arranged in a grid pattern.

Item 19. The method of Item 17 wherein said multilayer interlayer component sheets each comprise a first set of visible, light-reflecting bodies arranged in a first substantially coplanar arrangement in a first plane XY1 within said multilayer interlayer precursor thickness and a second set of visible, light-reflecting bodies arranged in a second substantially coplanar arrangement in a second plane XY2 within said multilayer interlayer precursor thickness that is substantially parallel to and different from said first plane.

Item 20. The method of Item 17 wherein said assembling step (b) further comprises inserting one or more optional interlayer component sheets.

Item 21. The method of Item 17 wherein said first and second interlayer component sheets are assembled in an adjacent stacked arrangement in assembling step (b).

Item 22. The method of Item 20 wherein said assembling step (b) further comprises inserting one or more optional spacer sheet(s) between said the first and second interlayer component sheets.

Item 23. The method of Item 20 wherein said assembling step (b) further comprises inserting one or more optional cap sheets adjacent an opposing or outwardly facing surface of at least one of the first and second interlayer component sheets.

Item 24. A method for forming a laminated composite glazing comprising first and second transparent substrates with an interlayer therebetween, said method comprising the steps of (a) providing an interlayer comprising an interlayer thickness; wherein said interlayer comprises a plurality of visible, light-reflecting bodies; wherein said plurality of visible, light-reflecting bodies includes a first set of visible, light-reflecting bodies arranged in a first substantially coplanar arrangement in a first plane within said interlayer thickness and a second set of visible, light-reflecting bodies arranged in a second substantially coplanar arrangement in a second plane within said interlayer thickness that is substantially parallel to and different from said first plane, said interlayer comprising a substrate and a plurality of visible, light-reflecting bodies; (b) assembling a laminated composite glazing precursor comprising first and second transparent substrates with said multilayer interlayer precursor therebetween; and (d) subjecting said laminated composite glazing precursor to laminating conditions to form a laminated composite glazing.

1. An interlayer for a laminated composite, said interlayer comprising an interlayer thickness, a polymer resin composition and a plurality of visible, light-reflecting bodies; wherein said plurality of visible, light-reflecting bodies includes a first set of visible, light-reflecting bodies arranged in a first substantially coplanar arrangement in a first plane XY1 within said interlayer thickness and a second set of visible, light-reflecting bodies arranged in a second substantially coplanar arrangement in a second plane XY2 within said interlayer thickness that is substantially parallel to and different from said first plane.

2. The interlayer of claim 1 wherein at least one of said first substantially coplanar arrangement and said second substantially coplanar arrangement comprises a grid pattern.

3. The interlayer of claim 2 wherein said first substantially coplanar arrangement comprises a first grid pattern and said second substantially coplanar arrangement comprises a second grid pattern.

4. The interlayer of claim 3 wherein said first grid pattern and said second grid pattern each comprise a rectangular grid pattern.

5. The interlayer of claim 4 wherein said second grid pattern is staggered from said first grid pattern.

6. The interlayer of claim 5 wherein said second grid pattern is linearly offset from said first grid pattern.

7. The interlayer of claim 4 wherein said second grid pattern is angularly offset from said first grid pattern.

8. The interlayer of claim 7 wherein first grid pattern is angularly offset from said second grid pattern at an angular offset angle of from 1 to 89 degrees.

9. A laminated composite glazing composite comprising first and second transparent substrates with an interlayer therebetween, said interlayer comprising a polymer resin composition and an interlayer thickness; wherein said interlayer comprises a plurality of visible, light-reflecting bodies; wherein said plurality of visible, light-reflecting bodies includes a first set of visible, light-reflecting bodies arranged in a first substantially coplanar arrangement in a first plane XY1 within said interlayer thickness and a second set of visible, light-reflecting bodies arranged in a second substantially coplanar arrangement in a second plane XY2 within said interlayer thickness that is substantially parallel to and different from said first plane.

10. The laminated composite glazing composite of claim 9 wherein at least one of said first substantially coplanar arrangement and said second substantially coplanar arrangement comprises a grid pattern.

11. The laminated composite glazing composite of claim 10 wherein said first substantially coplanar arrangement comprises a first grid pattern and said second substantially coplanar arrangement comprises a second grid pattern.

12. The laminated composite glazing composite of claim 11 wherein said first grid pattern and said second grid pattern each comprise a rectangular grid pattern.

13. The laminated composite glazing composite of claim 12 wherein said second grid pattern is staggered from said first grid pattern.

14. The laminated composite glazing composite of claim 13 wherein said second grid pattern is linearly offset from said first grid pattern.

15. The laminated composite glazing composite of claim 11 wherein said second grid pattern is angularly offset from said first grid pattern.

16. The laminated composite glazing composite of claim 15 wherein said first grid pattern is angularly offset from said second grid pattern at an angular offset angle of from 1 to 89 degrees.

17. A method for forming a laminated composite glazing comprising first and second transparent substrates with an interlayer therebetween, said method comprising the steps of (a) providing first and second interlayer component sheets, each interlayer component sheet comprising a substrate and a plurality of visible, light-reflecting bodies; (b) assembling said first and second interlayer component sheets to form a multilayer interlayer precursor; (c) assembling a laminated composite glazing precursor comprising first and second transparent substrates with said multilayer interlayer precursor therebetween; and (d) subjecting said laminated composite glazing precursor to laminating conditions to form a laminated composite glazing.

18. The method of claim 17 wherein said first and second interlayer component sheets each comprise a plurality of visible, light-reflecting bodies arranged in a grid pattern, or wherein said multilayer interlayer component sheets each comprise a first set of visible, light-reflecting bodies arranged in a first substantially coplanar arrangement in a first plane XY1 within said multilayer interlayer precursor thickness and a second set of visible, light-reflecting bodies arranged in a second substantially coplanar arrangement in a second plane XY2 within said multilayer interlayer precursor thickness that is substantially parallel to and different from said first plane, or wherein said assembling step (b) further comprises inserting one or more optional interlayer component sheets, or wherein said first and second interlayer component sheets are assembled in an adjacent stacked arrangement in assembling step (b).

19. The method of claim 18 wherein said assembling step (b) further comprises inserting one or more optional spacer sheet(s) between said the first and second interlayer component sheets, or wherein said assembling step (b) further comprises inserting one or more optional cap sheets adjacent an opposing or outwardly facing surface of at least one of the first and second interlayer component sheets.

20. (canceled)
